(19) United States
(12) Patent Application Publication
(10) Pub. No.: US 2003/0130991 A1
(43) Pub. Date: Jul. 10, 2003

(54) Knowledge discovery from data sets

(76) Inventors: Fidel Reijerse, St. Williams (CA); Timothy Davidge, Pokeno (NZ)

Correspondence Address: Burt Magen Esq., Vierra Magen Marcus Harmon & DeNiro, LLP, 685 Market Street, Suite 540, San Francisco, CA, 94105-4206, US

(21) Appl. No.: 10/106,873

(22) Filed: Mar. 26, 2002

Related U.S. Application Data
(60) Provisional application No. 60/279,320, filed on Mar. 28, 2001.

(51) Int. Cl. G06F 7/00

(52) U.S. Cl. 707/3

(57) ABSTRACT

A system is disclosed that allows a multi-dimensional data set to be mined as a single dimension data set so that useful information can be derived from that data set in an efficient manner. In one embodiment, the present invention allows for association rules and/or sequential patterns to be generated from M-dimensional data using a 1-dimensional mining process. In one implementation, one or more conditional items are appended to a data item in order to transform the multi-dimensional data to one-dimensional data.

This application claims the benefit of U.S. Provisional Application No. 60/279,320 entitled, “System and Method For Establishing Associative Characteristics In Genetic Data,” filed on Mar. 28, 2001, incorporated herein by reference.

### BACKGROUND OF THE INVENTION

1. Field of the Invention

The present invention is directed to technology for mining data.

2. Description of the Related Art

With the widespread use of databases and the explosive growth in their sizes, individuals and organizations are faced with the challenge of making use of this data. Traditionally, use of the data has been limited to querying a reliable data store via an application or report generating entity. While this mode of interaction was satisfactory for a wide class of well defined processes, it was not designed to support data exploration and decision support applications.

One step toward making better use of data is found in a relatively recent wave of activity in the database field, called data warehousing, which has been concerned with turning transactional data into more traditional relational databases that can be queried for summaries and aggregates of transactions. Data warehousing also includes the integration of multiple sources of data along with handling the host of problems associated with such an endeavor. These problems include: dealing with multiple data formats, multiple database management systems (DBMS), distributed databases, unifying data representation, data cleaning, and providing a unified logical view of an underlying collection of non-homogeneous databases.

Data warehousing is the first step in transforming a database system from a system whose primary purpose is reliable storage to one whose primary use is decision support. A closely related area is called On-Line Analytical Processing (OLAP). The current emphasis of OLAP systems is on supporting query-driven exploration of the data warehouse. Part of this entails pre-computing aggregates along data “dimensions” in a multi-dimensional data warehouse. Because the number of possible aggregates is exponential in the number of “dimensions,” much of the work in OLAP systems is concerned with deciding which aggregates to pre-compute and how to derive other aggregates (or estimate them reliably) from the pre-computed projections.

A problem with the OLAP approach is the query formulation: how can we provide access to data when the user does not know how to describe the goal in terms of a specific query? Examples of this situation are fairly common in decision support situations. For example, in a business setting, say a credit card or telecommunications company would like to query its database of usage data for records representing fraudulent cases. In a science data analysis context, a scientist dealing with a large body of data would like to request a catalog of events of interest appearing in the data. Such patterns, while recognizable by human analysts on a case-by-case basis, are typically very difficult to describe in a SQL query or even as a computer program in a stored procedure.

Another major problem with the OLAP approach is that humans find it particularly difficult to visualize and understand large data sets. Data can grow along three dimensions: the number of fields (also called dimensions or attributes), the number of cases (also called records) and the number of related tables—each comprising fields and records. Human analysis and visualization abilities do not scale to high dimensions and massive volumes of data.

Data mining attempts to solve the problems identified with OLAP. For the purposes of this document, data mining is defined as a process that enumerates structures over a set of input data. To use data mining most effectively, data mining can be used as a component in a knowledge discovery process. For the purposes of this document, a knowledge discovery process refers to the overall process of discovering useful knowledge from data while data mining refers to a particular step in this process. The additional steps in the knowledge discovery process, such as data preparation, data selection, data cleaning, incorporating appropriate prior knowledge, and proper interpretation of the results of mining, help ensure that useful knowledge is derived from the data. The knowledge discovery process includes the evaluation and possible interpretation of the “mined” patterns to determine which patterns may be considered new “knowledge.” In the knowledge discovery process, data is a set of facts (e.g. records in a database) and structure refers to either rules, patterns or models.

Data mining itself is not new. Examples of some existing data mining techniques are provided below.

One class of data mining technologies is referred to as Predictive Modeling. The goal is to predict an outcome from field(s) in a database. If the field being predicted is a numeric (continuous) variable (such as a physical measurement of e.g., height), then the prediction problem is a regression problem. If the field is categorical then it is a classification problem. There is a wide variety of techniques for classification and regression. The problem in general is to determine the most likely outcome value of the variable being predicted given the other fields (inputs), the training data (in which the target variable is given for each observation), and a set of assumptions representing one's prior knowledge of the problem.

In classification, the basic goal is to predict the most likely state of a categorical variable (the class). This is fundamentally a density estimation problem. If one can estimate the probability that the class C=c, given the other fields X=x for some feature vector x, then one could derive this probability from the joint density on C and X. However, this joint density is rarely known and very difficult to estimate. Hence, one has to resort to various techniques for estimating. These techniques include:

1. Density estimation, e.g., kernel density estimators or graphical representations of the joint density.

2. Metric-space based methods: define a distance measure on data points and guess the class value based on proximity to data points in the training set. An example is the K-nearest-neighbor method.

3. Projection into decision regions: divide the attribute space into decision regions and associate a prediction with each. For example, linear discriminant analysis finds linear separators, while decision tree or rule-based classifiers make a piecewise constant approximation of the decision surface. Neural nets find non-linear decision surfaces.

Another class of data mining technologies is referred to as clustering (also known as segmentation). Clustering does not specify fields to be predicted. Rather, clustering separates the data items into subsets that contain similar attributes. Since, unlike classification, we do not know the number of desired “clusters,” clustering algorithms typically employ a two-stage search: An outer loop over possible cluster numbers and an inner loop to fit the best possible clustering for a given number of clusters. Given the number k of clusters, clustering methods can be divided into three classes:

1. Metric-distance based methods: a distance measure is defined and the objective becomes finding the best k-way partition such as cases in each block of the partition are closer to each other (or centroid) than to cases in other clusters.

2. Model-based methods: a model is hypothesized for each of the clusters and the idea is to find the best fit that model to each cluster. If Mₗ is the model hypothesized for cluster l, (l ε{1, . . . , k}), then one way to score the fit of a model to a cluster is via the likelihood:

$$Prob ( {M}_{l} \vert D ) = Prob ( D \vert {M}_{l} ) \frac{Prob ( {M}_{l} )}{Prob ( D )}$$

The prior probability of the data D, Prob(D), is a constant and hence can be ignored for comparison purposes, while Prob(Mₗ) is the prior probability assigned to a model. In maximum likelihood techniques, all models are assumed equally likely and hence this term is ignored. A problem with ignoring this term is that models that are more complex are always preferred and this leads to overfitting the data.

3. Partition-based methods: basically, enumerate various partitions and then score them by some criterion. The above two techniques can be viewed as special cases of this class. Many artificial intelligence techniques fall into this category and utilize ad hoc scoring functions.

Another class of data mining technologies is referred to as Data Summarization, which includes extracting patterns that describe the data. There are two classes of methods which represent taking slices of the data across cases or fields. In the former, one would like to produce summaries of subsets: e.g., sufficient statistics, or logical conditions that hold for subsets. In the latter case, one would like to predict relationships between fields. This class of methods is distinguished from the above in that the goal is to find relationships between fields. One common method is called association rules. Another common method is called sequential patterns, which adds order to associations.

Associations are rules that state that certain combinations of values occur with other combinations of values with a certain frequency and certainty. A common application of this is market basket analysis where one would like to summarize which products are bought with what other products. While there can be many rules, typically only few such rules satisfy given support and confidence thresholds.

While using the above-described data mining technologies has improved the ability to use data for business intelligence, each of the above technologies includes limitations that has held back widespread adoption. Prediction modeling (including classification) and clustering are top-down approaches based on building a model of the data. Because they are based on modeling the data, the accuracy is only as good as the model, a different outcome can be achieved depending on how the data is viewed and they aggregate error. Furthermore, prediction and clustering technology are not very useful with random-like data sets.

Association rules technology doesn't use a model; therefore, it can be more accurate with random-like data and does not aggregate error. However, many shy away from using association rules because it only works on one-dimensional data sets. Many applications require the use of multi-dimensional data.

Thus, there is a need to provide an improved technology for mining data that overcomes the problems identified above.

### SUMMARY OF THE INVENTION

The present invention, roughly described, includes a system that allows a multi-dimensional data set to be mined as a single dimensional data set so that useful information can be derived from that data set in an efficient manner. In one embodiment, the present invention allows for N-dimensional association rules and/or sequential patterns to be generated from M-dimensional data using a 1-dimensional mining process, where N≧1 and M≧1. In one implementation, one or more conditional items are appended to a data item in order to transform the multi-dimensional data to single dimensional data. When the present invention is used with a one-dimensional association rules data mining tool, verifiable absolute rules can be built in a bottom-up manner.

One embodiment of the present invention includes accessing a multidimensional data set and converting that multi-dimensional data set to a single dimensional data set. The single dimensional data set includes information from multiple dimensions of the multi-dimensional data set. The single dimensional data set is then submitted to a data mining process. The data mining process can be an association rules data mining process, a sequential patterns process or other data mining process.

Another embodiment of the present invention includes modifying data by identifying one or more items for a set of transactions (or other related data) and identifying one or more conditions for each item. Conditional items are created for each condition and appended to the identified items. The modified data can then be submitted to a data mining process.

Another embodiment of the present invention includes converting a multi-dimensional data set to a one dimensional data set with sequence. The one dimensional data set with sequence is then submitted to an association rules data mining process (or other process). The association rules data mining process provides a result set of rules that identifies sequential patterns in the multi-dimensional data set.

The present invention can be accomplished using hardware, software, or a combination of both hardware and software. The software used for the present invention is stored on one or more processor readable storage devices including hard disk drives, CD-ROMs, DVDs, optical disks, floppy disks, tape drives, RAM, ROM or other suitable storage devices. In one embodiment, the software can be performed by one or more processors in communication with a storage device. In alternative embodiments, some or all of the software can be replaced by dedicated hardware including custom integrated circuits, gate arrays, FPGAs, PLDs, and special purpose processors. One example of a hardware system that can implement all or portions of the present invention includes a processor, storage devices, peripheral devices, input/output devices, a display and communication interfaces, in communication with each other as appropriate for the particular implementation.

The advantages of the present invention will appear more clearly from the following description in which the preferred embodiment of the invention has been set forth in conjunction with the drawings.

### BRIEF DESCRIPTION OF THE DRAWINGS

FIG. 1 is a flow chart describing one embodiment of the present invention.

FIG. 2 is a flow chart describing one embodiment of a method for processing data prior to mining.

FIG. 3 is a flow chart describing a process for modifying data.

FIG. 4 is a flow chart describing one embodiment for adding sequence information to data.

FIG. 5 is a flow chart describing one embodiment for processing the output of a data mining process.

FIG. 6 is a block diagram of an exemplar computing platform that can be used to implement the present invention.

### DETAILED DESCRIPTION

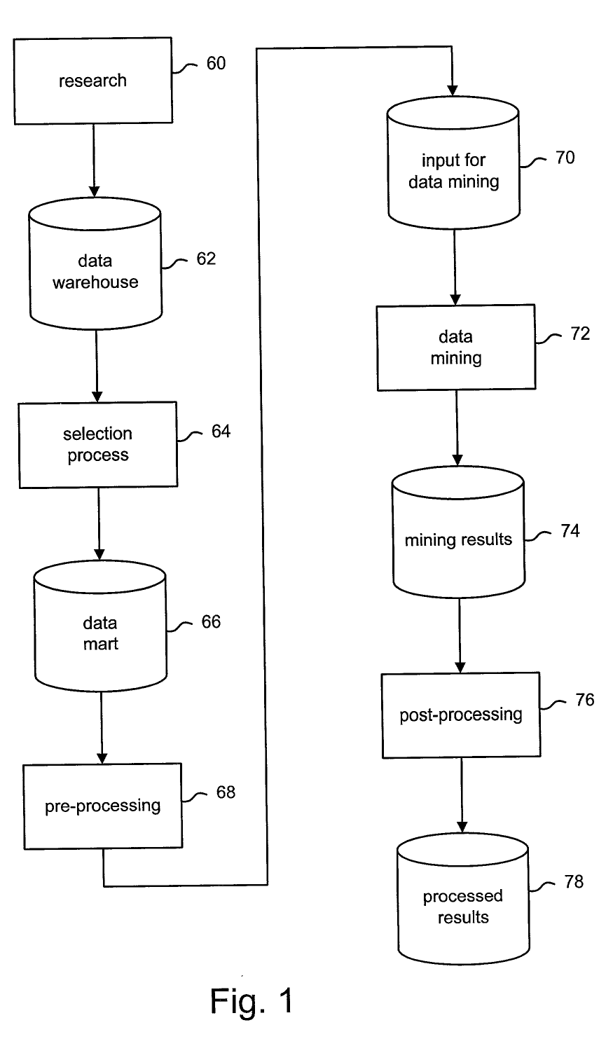

FIG. 1 is a flowchart describing one embodiment of the present invention. The first step depicted in FIG. 1 is research step 60. In this step, data is researched, received and stored in various files. For example, research step 60 can include a bank acquiring data about its customers, a geneticist acquiring data about an experiment, an insurance company acquiring data about its customers or potential customers, a government agency acquiring data about objects/people/events, etc. The basic purpose of step 60 is to acquire data, which will be used in the process described below. The data acquired in step 60 is stored in data warehouse 62. In one embodiment, data warehouse 62 can be any structure on any storage device. For example, data warehouse 62 can include a relational database, directory, or other data store. In some implementations, data warehouse 62 stores all data collected without the data being sorted. In other implementations, the data can be sorted.

In step 64, all or a subset of the data in data warehouse 62 is selected for data mining. For example, if an insurance company has the stored data on all transactions and all the personal data for all of its customers in data warehouse 62, a portion of that data may be selected for mining. The portion of data selected for mining is accessed in the data warehouse and stored in data mart 66. Data mart 66 can be a database, directory, or any other data structure. The exact structure of the data mart is not important. For example, data mart 66 can also be a comma-delimited file. Thus, data mart 66 may represent a portion (or all) of the data stored in data warehouse 62. In some embodiments, a process can add further data to the data stored in data mart 66. One or more processes can review the data in data mart 66 and add further metrics based on that data. For example, if data mart 66 stores the street address and town of each customer, a process can add further fields to the data indicating the county, or region in the country, television market, etc.

In step 68, the data from data mart 66 is pre-processed so that it can be used for data mining. More details of step 68 will be described below. The processed data from step 68 is then stored in one or more input files 70. These input files are submitted to data mining tool 72. The output of the data mining tool is depicted as mining results 74. There are various formats for the mining results. Typically, the format is dependent on the actual tool used. In step 76, the mining results are post-processed to create processed results 78. In one implementation, the mining results are placed into a database and several queries are run against that database. For example, if the mining results indicate a set of association rules or sequential patterns, then these rules can be placed in a database and based on the current data in either data mart 66 or data warehouse 62, the system can determine which rules are currently active.

Data mining tool 72 can be any of various suitable data mining tools known in the art. For example, data mining tools implementing the data mining technologies described above can be used. Additionally, a sequential patterns data mining tool can be used. More information about sequential patterns is discussed below. Other data mining tools known in the art and not mentioned above can also be used with the present invention. That is because the present is not limited to any one particular data mining tool or technology.

In one embodiment, data mining tool 72 is an association rules data mining tool. Association rules data mining tools output result sets that include associations rules. Associations rules state that certain combinations of values within a particular transaction occur with other combinations of values with a certain frequency and certainty. A transaction is a set of one or more items obtained from a finite item domain, and a dataset is a collection of transactions. A set of items will be referred to more succinctly as an itemset. The support of an itemset I, denoted sup(I), is the number of transactions in the data-set that contain I. An association rule, or just rule for short, consists of an itemset called antecedent, and an itemset disjoint from the antecedent called the consequent. A rule is denoted as A→C where A is the antecedent and C the consequent. The support of an association rule is the support of the itemset formed by taking the union of the antecedent and consequent (A∪C). The confidence of an association rule is the probability with which the items in the antecedent A appear together with items in the consequent C in the given data-set. More specifically:

$$conf ( A \to C ) = \frac{sup ( A ⋃ C )}{sup ( A )}$$

The association rule mining problem is to produce all association rules present in a data-set that meet specified minimums on support and confidence.

The improvement of a rule is defined as the minimum difference between its confidence and the confidence of any proper sub-rule with the same consequent. More formally, for a rule A→C:

imp(A→C)=min(∀A′⊂A,conf(A→C)−conf(A′→C))

If the improvement of a rule is positive, then removing any non-empty combination of items from its antecedent will drop its confidence by at least its improvement. Thus, every item and every combination of items present in the antecedent of a large-improvement rule is an important contributor to its predictive ability. A rule with negative improvement is typically undesirable because the rule can be simplified to yield a proper sub-rule that is more predictive, and applies to an equal or larger population due to the antecedent containment relationship. An improvement greater than 0 is thus a desirable constraint.

One example of an association rules data mining tool is Apriori, or IntelligentMiner, by IBM. Technology associated with Apriori can be found in U.S. Pat. No. 5,794,209, Rakesh Agrawal, Ramakrishnan Srikant, “System and Method for Quickly Mining Association Rules in Databases.” Another example of a suitable association rules data mining tool is DenseMiner by IBM. Technology used by DenseMiner is described in U.S. Pat. No. 6,138,117, Bayardo, “Method and System for Mining Long Patterns from Databases.” IntelligentMiner and DenseMiner are one-dimensional association rules mining tools. The input to those tools is one-dimensional data. Other association rules mining tools can also be used with the present invention.

To operate some association rules tools, a user specifies a data file, a result, a minimum confidence, a minimum support, and additional statistical parameters such as improvement or lift. In one embodiment, the specified data file is a two column comma-delimited flat file. The left hand column includes a transaction number. The right hand column includes an integer that represents an item. There may be multiple rows having the same transaction number. The output of an association rules tools is a set of rules. For each rule, the confidence, support and other statistical evaluations (e.g. lift or improvement) can be provided for the rule. If the data mining tool does not calculate support, confidence and/or improvement, then those values can be calculated during the post-processing stage.

The present invention allows multi-dimensional data to be rolled up into single-dimensional data to be input into a one dimensional association rules mining tool. The output from the one dimensional association rules mining tool, which is traditionally one-dimensional data, can represent multi-dimensions when using the present invention.

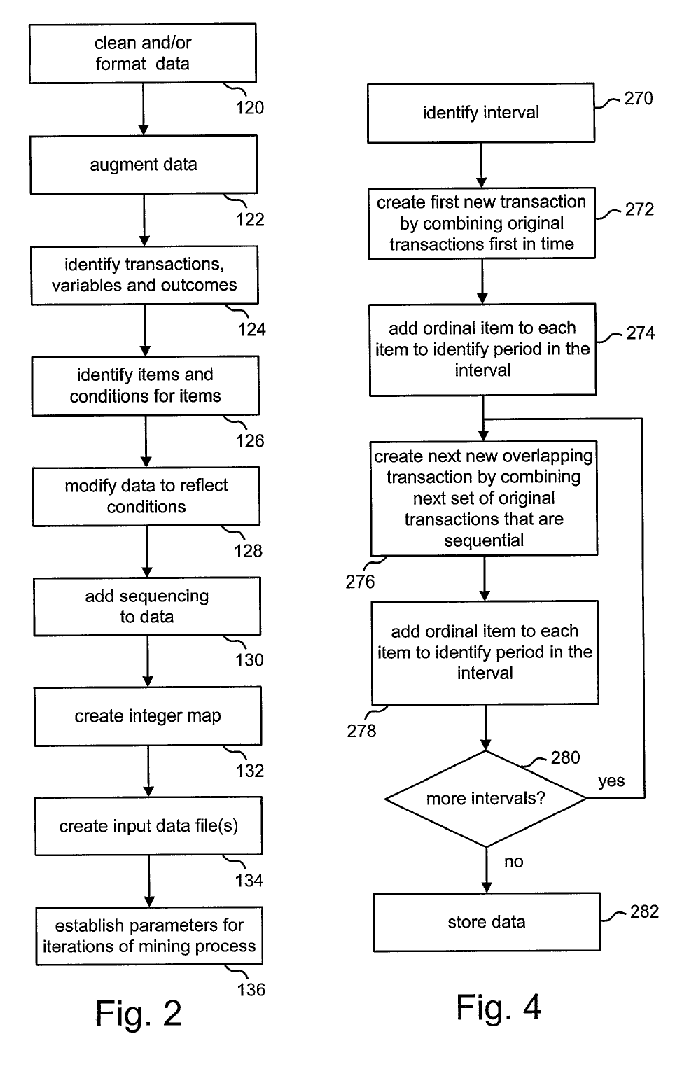

FIG. 2 is a flowchart describing one embodiment for pre-processing the data (see step 68 of FIG. 1). In step 120 of FIG. 2, the data is cleaned for errors, syntax is validated and the data is stored electronically in a suitable format. In step 122, the data can be augmented. That is, additional fields can added to each record. These additional fields can add new data which is calculated based on the existing data. Examples include adding a county to an address, adding a suffix to a zip code, etc. Step 122 is optional, and is dependent on the particular application. In step 124, transactions, variables, and outcomes need to be identified for the data. That is, data is broken up into a set of transactions. Within each transaction, it has to be determined what are variables and what are outcomes of the transaction. Not all embodiments will include outcomes.

In step 126, items are determined or identified from each transaction and conditions are identified from each item. The variables and outcomes that are identified above are candidates to be items. An item is anything that is a distinct unit of a transaction. Consider the example of a store tracking data about its customers and purchases. A transaction can be a shopping cart and the items can be each product purchased in that shopping cart. In a banking example, the transaction can be a customer and the item can be the actions of that particular customer. In another banking example, a transaction can be an ATM transaction and the items can be each action performed by a particular customer at the ATM during a visit. From the other variables and outcomes that are not items, conditions are determined for each item. Consider the shopping basket where products purchased are the items. Conditions on the item can be the quantity of products purchased, whether it was on sale, whether a coupon was used, etc. In the banking example, conditions on the item could include income of the customer, demographics, location of the ATM, etc.

In step 128, the data is modified to reflect the conditions identified above. Each item can be edited or modified to add the information of the condition. In one embodiment, the data is in integer format. Step 128 includes converting the data to text format and then appending information to the text data to reflect information about the conditions of interest. In some embodiments, the data is already in text format prior to adding information about the condition.

To understand steps 124-128, consider the following example. The table below is an example of generic data:

| record | variable 1 | variable N | outcome 1 | outcome M |
|---|---|---|---|---|
| 1 | 1 | 0 | y | h |
| 2 | 0 | 1 | n | m |
| 3 | 1 | 0 | y | l |
| 4 | 1 | 0 | n | l |

In step 124, it may be determined that each record in the data above is a transaction. Each record includes N variables and M outcomes. For example purposes, assume each variable and each outcome will be an item. Each item has one condition, which is the state of the variable or outcome. In this example, the variables can be in one of two states: equal to one or equal to zero. Outcome 1 has two states: y or n. Outcome M has three states: h, m, l. Additional outcomes and variables can have more or less states than described above. In step 128, the data is converted to text. Thus, a variable 1 would become var1. Variable N will become varN, etc. In addition, step 128 includes adding conditions to each of the items. The text added to the items is called a conditional element. For example, the conditional element “_{—}1” can be added to the item “var1” to add the state of variable 1. Thus, the data is modified to become the format of the table below:

| record | | | | |
|---|---|---|---|---|
| 1 | var1_1 | varN_0 | out1_y | outM_h |
| 2 | var1_0 | varN_1 | out1_n | outM_m |
| 3 | var1_1 | varN_1 | out1_y | outM_1 |
| 4 | var1_1 | varN_1 | out1_n | outM_1 |

That data can also be represented in two column format to help understand how the data will be stored in the two column input file for the mining tool:

| transaction | item |
|---|---|
| 1 | var1_1 |
| 1 | varN_0 |
| 1 | out1_y |
| 1 | outM_h |
| 2 | var1_0 |
| 2 | varN_1 |
| 2 | out1_n |
| 2 | outM_m |
| 3 | var1_1 |
| 3 | varN_1 |
| 3 | out1_y |
| 3 | outM_1 |
| 4 | var1_1 |
| 4 | varN_1 |
| 4 | out1_n |
| 4 | outM_1 |

In step 130, sequencing is added to the data. Step 130 is optional and one embodiment of the present invention uses step 130 to prepare the data for a sequential pattern analysis. More information about step 130 will be provided below.

In performing a timing process, it may be more efficient to use integers rather than text. Thus, one embodiment converts the text described above to integers. To accomplish this, one implementation includes an integer map. In step 132, that integer map is created. The integer map provides a unique mapping of each text element to an integer. Below is a portion of exemplar integer map:

| integer | item |
|---|---|
| 0 | var1_0 |
| 1 | var1_1 |
| | . . . |
| 13 | varN_0 |
| 14 | varN_1 |
| 15 | out1_y |
| 16 | out1_n |
| | . . . |
| 28 | outM_h |
| 29 | outM_m |
| 30 | outM_1 |

In one embodiment, the integer map assigns each field (e.g. column of data) a number and combines that number with another number used to identify each condition. Thus, a particular field may be assigned “1” (e.g. for Variable 1) and a particular condition can be assigned “1,” thus, var1_{—}1 would be represented by “11.”

Using the integer map, the data in the two-column format table can be replaced with integers as follows:

| transaction | item |
|---|---|
| 1 | 1 |
| 1 | 13 |
| 1 | 15 |
| 1 | 28 |
| 2 | 0 |
| 2 | 14 |
| 2 | 16 |
| 2 | 29 |
| 3 | 1 |
| 3 | 14 |
| 3 | 15 |
| 3 | 30 |
| 4 | 1 |
| 4 | 14 |
| 4 | 16 |
| 4 | 30 |

In step 134 an input file is created for submission to the mining tool. For example, the data described above can be converted to a comma-delimited file for submission to an association rules mining tool; where the first number on each line represents the transaction and the second the second number represents the item:

1, 1
1, 3
1, 5
1, 8
2, 0
2, 4
2, 6
2, 9
3, 1
3, 4
3, 5
3, 10
4, 1
4, 4
4, 6
4, 10

In one embodiment, the input file is sorted in ascending order by transaction order and then by a variable/condition number. Depending on the mining tool used, the input file is then converted into a binary file. In step 136, parameters for the iterations of the mining process are established. In one embodiment, parameters for each iteration include a result (e.g. consequent of one or more rules), a minimum confidence, a minimum support and other statistical measures such as lift or improvement. In one embodiment, an association rules tool can be requested to produce rules having a confidence of 100%. In one implementation, a batch file can be set up to run the iterations of the mining tool on the data. Each iteration corresponds to a different result. Note that the output of some mining tools is a set of integers which are converted back to text using the integer map.

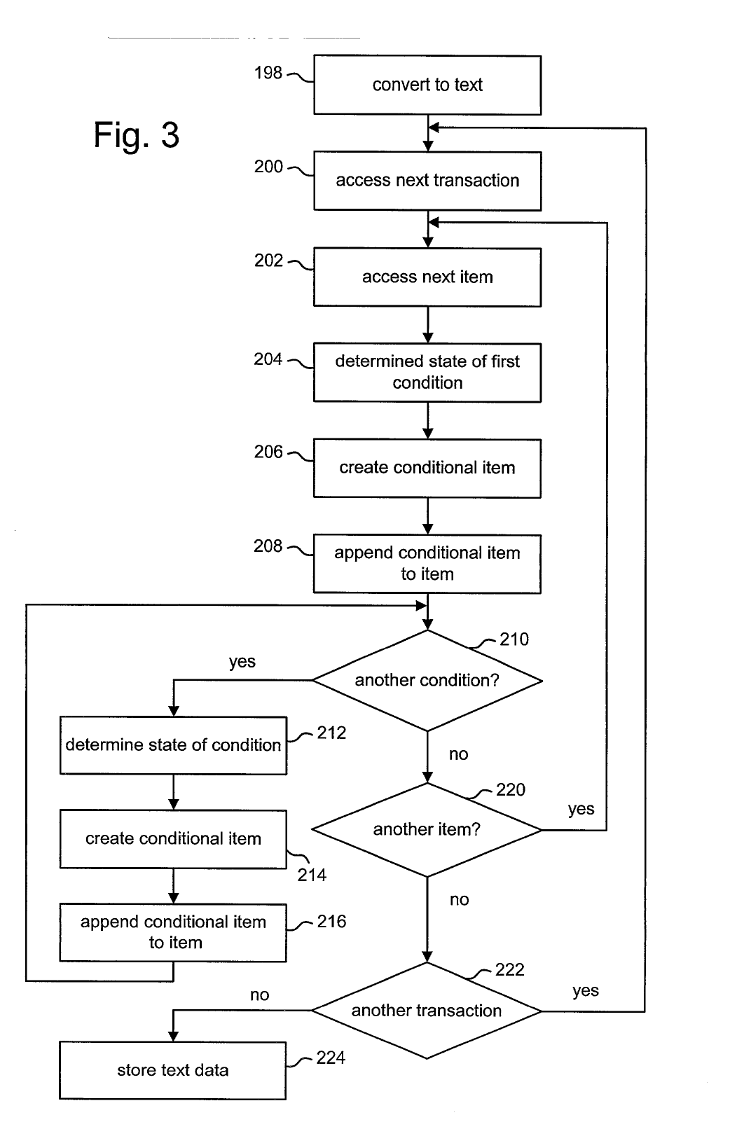

FIG. 3 is a flowchart describing more details of the process of modifying the data to reflect conditions (see step 128 of FIG. 2). In step 198, the data is converted from digits to text, as described above. Considering the example above, the text “var1” is created. If the data is already text, then step 198 may not need to be performed. In step 200, the system accesses the next transaction of data. If this is the first time that step 200 is being performed, then the first transaction is accessed. In step 202, the next item in that transaction is accessed. It is the first time that step 202 is being performed for a particular transaction, and the first item is accessed. In step 204, the system determines the state of the first condition. It is possible that an item may have multiple conditions. For example, an item may be a product purchased in a shopping basket and it may have three conditions: quantity, on sale/not on sale, coupon/no coupon. The first condition is accessed in state 204. The state of the condition is determined. For example, if the condition is whether a price has increased, the system may need to look to two different prices and do a calculation to determine whether the price has increased. In step 206, a conditional element is created. In one embodiment, the conditional element is text reflecting the state of the condition—e.g., “NoCoupon.” In step 208, the condition element is appended to the item. For example, if the item is something purchased in a shopping basket and condition is whether it is bought with a coupon or not, then the condition “NoCoupon” can be appended to the item “Soap” to become “Soap_NoCoupon.” In step 210, it is determined whether there are any more conditions to consider for the current item under consideration. If there are more conditions to consider, then the method continues at step 212 and determines the state of the next condition. In step 214, a conditional item is created for the next condition. In step 216, the new conditional item is appended to the item. After step 216, the method loops back to step 210. If, in step 210, it is determined that there are no more conditions to consider for the current item under consideration, then the method continues with step 220 and determines whether there are any more items to consider for the current transaction. If there are more items for the current transaction, then the process loops back to step 202 and accesses the next item. If there are no more items for the current transaction, then the current transaction is completed. In step 222, the system determines whether there are any more transactions to consider. If there are more transactions to consider, then the method loops back to step 200 and considers the next transaction. If there are no more transactions to consider then the text data described above is stored in step 224.

To better understand FIGS. 2 and 3, consider an example involving genetics research and an experiment to learn about cancer. A mouse susceptible to cancer is bred with a mouse that is not susceptible to cancer (or not very susceptible to cancer). A population of mice is created. The mice are exposed to a controlled environmental factor known to be a catalyst to the disease. The experiment measures how many tumors each mouse gets and whether the tumors are malignant. The research experiment takes parts of the tail of each mouse and uses genetic material to add markers to the genes. The markers are used to determine whether genes are from the original susceptible parent or the original resistant parent. As it is well known, genes are arranged in pairs. For a particular marker, if both genes (or at least that portion of the genes associated with the marker) are received from the parent not susceptible to cancer, then the marker is considered homozygous. If one gene of the pair was from one original parent and the other gene was from the other original parent, then that marker is considered heterozygous. The above-described research can be used to create a database. Below is a table describing a portion of the database:

| mouse | C4M37 | C6M4 | C7M69 | C16M102 | tummors |
|---|---|---|---|---|---|
| 1 | 1 | 1 | 0 | 0 | 2 |
| 2 | 0 | 0 | 1 | 1 | 9 |
| 3 | 1 | 1 | 0 | 1 | 22 |
| 4 | 1 | 0 | 0 | 1 | 8 |

In the above table, the left-hand column specifies a particular mouse specimen. For each row, there is data for various markers. The table above shows data for four markers. However, more than four markers or less than four markers can be used. The marker “C4M37” identifies marker 37 on chromosome 4. The right most column in the above table indicates the number of tumors for each mouse. In one embodiment, the table above is an example of data that appears in a data mart. Alternatively, the table above can be found in a data warehouse. After the above data is converted to text, conditional items are appended to the items based on the process of FIG. 3. Assume for data mining purposes each transaction is a mouse and each item is a marker. The conditions for the item are whether the marker indicates heterozygous or homozygous. Where the data for a maker is “1,” a conditional element is added to the text for the marker (e.g. C4M37) to indicate that the marker is homozygous. An example of a suitable conditional element is “_hom.” Where the data for a maker is “0,” a conditional element is added to the text for the marker to indicate that the marker is heterozygous. An example of a suitable conditional element is “_het.” The data from the above table is then modified to the following format:

| | | | | | |
|---|---|---|---|---|---|
| 1 | C4M37_hom | C6M4_hom | C7M69_het | C16M102_het | low_tumors |
| 2 | C4M37_het | C6M4_het | C7M69_hom | C16M102_hom | med_tumors |
| 3 | C4M37_hom | C6M4_het | C7M69_het | C16M102_hom | hi_tumors |
| 4 | C4M37_hom | C6M4_het | C7M69_het | C16M102_hom | med_tumors |

This data can also be represented in two-column format:

| transaction | item |
|---|---|
| 1 | C4M37_hom |
| 1 | C6M4_hom |
| 1 | C7M69_het |
| 1 | C16M102_het |
| 1 | low_tumors |
| 2 | C4M37_het |
| 2 | C6M4_het |
| 2 | C7M69_hom |
| 2 | C16M102_hom |
| 2 | med_tumors |
| 3 | C4Mit37_hom |
| 3 | C6Mit4_het |
| 3 | C7Mit69_het |
| 3 | C16Mit102_hom |
| 3 | hi_tumors |
| 4 | C4M37_hom |
| 4 | C6M4_het |
| 4 | C7M69_het |
| 4 | C16M102_hom |
| 4 | med_tumors |

As described above, an integer map is created and the text is replaced with integers. The two-column file is then submitted to an association rules mining tool to create a set of associational rules. One embodiment can specify to the mining tool to only output rules with 100% confidence. The resulting rules can be filtered to identify those rules that predict a high amount of tumors. For example, one rule might read:

C4M37_hom+C6M4_het+C7M69_het→hi_tumors.

This rule is read as follows: if marker C4M37 is homozygous and marker C6M4 is heterozygous and the marker C7M69 is heterozygous, then there is a high tumor count found in the mice. These rules can be used to identify linkages between genes and diseases. Additionally, because these rules have conditional items, they therefore have multi-dimensional information in a one-dimensional format.

FIG. 4 is a flowchart describing a process for adding sequencing to the data (see step 130, FIG. 2). In one embodiment, the process of FIG. 4 is performed in order to identify sequential patterns in data. In some implementations, sequential patterns are used to understand behavior over a sequence of events. An example of a sequential pattern is the knowledge that if a customer performs act A during a first time period, then that person is likely to perform act B during a second time period. Alternatively, perhaps data can show that if the weather is a first condition on a first day, then it is likely to be a second condition on a second day. There are unlimited numbers of applications for sequential patterns. One embodiment of the process of FIG. 4 allows a sequential pattern analysis to be performed using an association rules mining tool. For example, a multi-dimensional data set can be transformed to a one-dimensional data set for submission to the association rules mining tool. The process of FIG. 4 can be also used with other data mining tools.

In step 270 of FIG. 4, an interval is determined or identified. That is, a sequential pattern rule that is being sought to be discovered is in the form—if A in interval 1, then B in interval 2. The definition of the intervals must be determined. Depending on the application, an interval can be a minute, a day, a week, a month, a set of number of trips to a checkout counter, other periods of time, etc. The determination of the interval is based on the application. In one embodiment, the interval should be uniform for the entire data set. In step 272, new transactions are identified. The first new transaction is created by combining the first set of original transactions in time. For example, if the transactions that exist in the database are events that happened in a particular day and the interval is a week, then seven transactions are combined to form an interval. This new interval then becomes the new transaction. If the transactions are events that occur over a particular week, and the interval becomes two weeks, then the first two transactions are combined for the first interval and they become the first transaction. In step 274, ordinal items are added to each item to indicate what period within the interval they originated from. In one embodiment, an ordinal item is a conditional item that identifies order, sequence or time. In the above example where the transactions were initially days and they were combined into an interval of a week, an ordinal item will be added to each transaction to indicate whether the transaction was for Sunday, Monday, Tuesday, Wednesday, Thursday, Friday, or Saturday. Thus, the ordinal items could be “_Sunday”, “_Monday” “_Tuesday”, “_Wednesday”, “_Thursday”, “_Friday”, or “_Saturday”. Alternatively, the ordinal items could be “_day1”, “_day2” etc. If the interval was combining two one-week transactions, then the ordinal item added indicates whether the item is from week one or week two (e.g., _week1 or _week2) of the interval. In one embodiment, the intervals will overlap. The degree of overlapping is implementation independent. For example, if the intervals are two week intervals combining transactions previously showing operations over a week, then each week will be part of two intervals where it would be the first week of one interval and the second week of another interval. In the embodiment where seven days of data are combined to form an interval, each day may be part of seven intervals.

In step 276, the next new transaction, which overlaps the previously created new transaction, is created by combining a new set of original transactions that were sequential. In step 278, ordinal items are added for the new transaction indicating the appropriate periods. If there are more intervals to process (step 208), then the process loops back to step 276. If there are no more intervals to process, then the data is stored in step 282.

The process of FIG. 4 is better understood by considering the following example. Assume that a grocery store wishes to anticipate what products may be purchased during the coming week. To accomplish this, the knowledge discovery process will look for rules stating that if a first set of products is purchased by a customer in the first week, then a second set of products will be purchased by that customer during the next week. For example:

if product1 (first week)+product2 (first week)+product3 (first week)→product 4(second week).

These rules form buying patterns for the customers and create a knowledge base from which the grocery store is able to anticipate future demand and need. By understanding what has been purchased the prior week, it is possible to query the rules to determine which are “active.” That is, compare the antecedent of each rule against purchases in the current week. If the antecedent is true for the current week (e.g. a person purchased product1, product2 and product3), then that rule is active and the store will assume that the consequent will happen next week (e.g. the customer will purchase product 4). Thus, the store will have an understanding of what items will be necessary to carry in inventory (stock) and what shelf areas will require the greatest restocking.

Assume that each customer is uniquely identified (e.g. by a loyalty card or payment card) An exemplar data mart may be as follows:

| Customer Id | item | quantity | Coupon | week |
|---|---|---|---|---|
| . . . | | | | |
| 1024 | item1 | 2 | No | 33 |
| 1024 | item3 | 5 | Yes | 33 |
| 1024 | item4 | 1 | No | 33 |
| 1024 | item2 | 3 | No | 33 |
| . . . | | | | |
| 1024 | item1 | 2 | No | 34 |
| . . . | | | | |
| 3089 | item1 | 3 | Yes | 33 |
| . . . | | | | |
| 3089 | item5 | 1 | No | 34 |
| . . . | | | | |

Step 124 of FIG. 2 involves identifying the transactions. For purposes of this example, the initial transaction will be a particular customer's purchases during a week. Thus, in the table below, the transaction (e.g. “cust_{—}1024_week33”) identifies and is a composite of a particular customer (e.g. “cust_{—}1024”) and a particular week (e.g. “week33”). Regarding step 126, the items for each transaction will be the products purchased during the week. For this example, assume that there are two conditions added to the item. The first condition is a measure of quantity. The example will categorize quantity into three categories: purchase of one (1Q), purchase of less than 5 (lowQ) or purchase of 5 or more (hiQ). The second condition is whether the item was purchased with a coupon. In step 128, the data will be modified to be in the following form:

| Transaction | Item and Conditional Item |
|---|---|
| cust_1024_week33 | item1_lowQ_noCoupon |
| cust_1024_week33 | item3_hiQ_Coupon |
| cust_1024_week33 | item4_1Q_noCoupon |
| cust_1024_week33 | item2_lowQ_noCoupon |
| . . . | |
| cust_1024_week34 | item1_lowQ_noCoupon |
| . . . | |

Next, sequencing is added according to the process of FIG. 4. In step 270, an interval is created to be two weeks. This interval is chosen for example purposes only and many other intervals can also be chosen. The transaction will become an interval for each customer. Thus, in a given year there will be 52 overlapping two-week intervals. The first week of the year will be included as the last half of an interval started the previous year and as the first half of an interval that includes the first two weeks of the present year. In one embodiment, orphan data is eliminated.

For example, data that is not placed in a complete interval will be discarded, such as the first week of data mentioned above that is included as the last half of an interval started the previous year and data that is at the end of the monitoring period.

Within each interval a period is chosen. In many embodiments the period identifies the original transaction (e.g. customer 1024 during week 33) for the item. In this case, the interval will consist of two one week periods. For example, step 276 of FIG. 4 combines week 33 and week 34 to create a new transaction cust_{—}1024_week33_{—}34. Step 278 adds ordinal items (e.g. _wk1 or _wk2) to each item to indicate whether the item is for the first period of the interval (e.g. week 33) or the second period of the interval (e.g. week 34). After the process of FIG. 4, the data is as follows:

| Transaction | Item |
|---|---|
| . . . | |
| cust_1024_Week 32_33 | item1_lowQ_noCoupon_wk2 |
| cust_1024_Week 32_33 | item3_hiQ_Coupon_wk2 |
| cust_1024_Week 32_33 | item4_1Q_noCoupon_wk2 |
| cust_1024_Week 32_33 | item2_lowQ_noCoupon_wk2 |
| . . . | |
| cust_1024_Week 33_34 | item1_lowQ_noCoupon_wk1 |
| cust_1024_Week 33_34 | item3_hiQ_Coupon_wk1 |
| cust_1024_Week 33_34 | item4_1Q_noCoupon_wk1 |
| cust_1024_Week 33_34 | item2_lowQ_noCoupon_wk1 |
| . . . | |
| cust_1024_Week 33_34 | item1_lowQ_noCoupon_wk2 |
| . . . | |
| cust_1024_Week 34_35 | item1_lowQ_noCoupon_wk1 |
| . . . | |

The above table is created as part of step 130 of FIG. 2. As per step 132, an example integer map of unique values will be created. Below is an example of an integer map. Each transaction and each combination of items with conditional items is assigned a unique integer.

| . . . | |
|---|---|
| customer1024_Week_32_33 | 205 |
| customer1024_Week_33_34 | 206 |
| customer1024_Week_34_35 | 207 |
| . . . | |
| item1_1Q_noCoupon_wk1 | 4020 |
| item1_1Q_Coupon_wk1 | 4021 |
| item1_lowQ_noCoupon_wk1 | 4022 |
| item1_lowQ_Coupon_wk1 | 4033 |
| item1_hiQ_noCoupon_wk1 | 4044 |
| item1_hiQ_Coupon_wk1 | 4045 |
| item2_1Q_noCoupon_wk1 | 4046 |
| item2_1Q_Coupon_wk1 | 4047 |
| item2_lowQ_noCoupon_wk1 | 4048 |
| item2_lowQ_Coupon_wk1 | 4049 |
| item2_hiQ_noCoupon_wk1 | 4050 |
| item2_hiQ_Coupon_wk1 | 4051 |
| item3_1Q_noCoupon_wk1 | 4052 |
| item3_1Q_Coupon_wk1 | 4053 |
| item3_lowQ_noCoupon_wk1 | 4054 |
| item3_lowQ_Coupon_wk1 | 4055 |
| item3_hiQ_noCoupon_wk1 | 4056 |
| item3_hiQ_Coupon_wk1 | 4057 |
| item4_1Q_noCoupon_wk1 | 4058 |
| item4_1Q_Coupon_wk1 | 4059 |
| item4_lowQ_noCoupon_wk1 | 4060 |
| item4_lowQ_Coupon_wk1 | 4061 |
| item4_hiQ_noCoupon_wk1 | 4062 |
| item4_hiQ_Coupon_wk1 | 4063 |
| . . . | |
| item1_1Q_noCoupon_wk2 | 8020 |
| item1_1Q_Coupon_wk2 | 8021 |
| item1_lowQ_noCoupon_wk2 | 8022 |
| item1_lowQ_Coupon_wk2 | 8033 |
| item1_hiQ_noCoupon_wk2 | 8044 |
| item1_hiQ_Coupon_wk2 | 8045 |
| item2_1Q_noCoupon_wk2 | 8046 |
| item2_1Q_Coupon_wk2 | 8047 |
| item2_lowQ_noCoupon_wk2 | 8048 |
| item2_lowQ_Coupon_wk2 | 8049 |
| item2_hiQ_noCoupon_wk2 | 8050 |
| item2_hiQ_Coupon_wk2 | 8051 |
| item3_1Q_noCoupon_wk2 | 8052 |
| item3_1Q_Coupon_wk2 | 8053 |
| item3_lowQ_noCoupon_wk2 | 8054 |
| item3_lowQ_Coupon_wk2 | 8055 |
| item3_hiQ_noCoupon_wk2 | 8056 |
| item3_hiQ_Coupon_wk2 | 8057 |
| item4_1Q_noCoupon_wk2 | 8058 |
| item4_1Q_Coupon_wk2 | 8059 |
| item4_lowQ_noCoupon_wk2 | 8060 |
| item4_lowQ_Coupon_wk2 | 8061 |
| item4_hiQ_noCoupon_wk2 | 8062 |
| item4_hiQ_Coupon_wk2 | 8063 |

In step 134 of FIG. 2, an input file will be created. The data that is the output of FIG. 4 is changed by replacing the text with integers according to the integer map. Below is portion of an example input file:

. . .
205, 8022
205, 8057
205, 8058
205, 8048
. . .
206, 4022
206, 4057
206, 4058
206, 4048
. . .
206, 8022
. . .
207, 4022

The above input file is provided to a data mining tool. In one embodiment, the data can be provided to an associations rule data mining tool that create association rules. An exemplar rule may be as follows:

item1_{—}1Q_noCoupon_wk1+item4_hiQ_noCoupon_wk1→item1_{—}1Q_noCoupon_wk2

The above rule can be checked against the purchasing data for the current week to see how many times a customer purchased one quantity of item 1 without a coupon and five or more quantities of item 4 without a coupon. For each time a customer purchased one quantity of item 1 without a coupon and five or more quantities of item 4 without a coupon, the store can assume that one quantity of item 1 will be purchased the following week. That is, if 20 customers purchased one quantity of item 1 without a coupon and five or more quantities of item 4 without a coupon this week, then the store is likely to sell twenty quantities of item 1 next week.

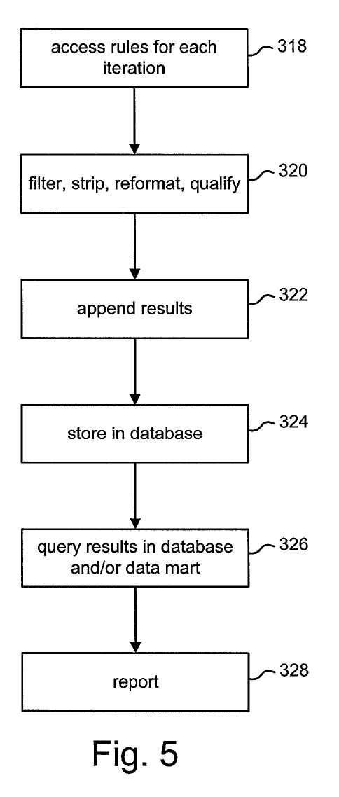

FIG. 5 is a flowchart describing a method for processing the data after data mining. (See step 76 of FIG. 1.) In step 318 of FIG. 5, the sets of rules for each iteration of data mining are accessed. In step 320, the rules are filtered, stripped of data, reformatted and/or qualified. For example, the rules can be filtered to identify rules with 100% confidence. Additionally, unwanted data that is part of the results can be removed. The reformatting is done to accommodate databases and tools used, and to make the data easier to read. Step 320 is optional and some embodiments do not perform all or part of step 320. Additionally, step 320 can be performed at other times during the process, such as after step 322, after step 324, etc. The sets of rules are combined in step 322. The rules are not changed in step 322. Rather, they are all deposited into one list, file, structure, table, set, etc. In step 324, the combined rules are stored in a database. In alternative environments, the combined rules can be stored in other data structures. In various embodiments, the combined results can be stored in a data warehouse or data mart. In one alterative, these results can be placed in a data mart and the data mart can be used in another iteration of the process of FIG. 1. In step 326, queries are performed on the combined rules. In step 328, the results of the queries are also used to report back to a user. The reporting can be in the form of using a monitor to display text or graphics, printing a document, storing information in a file, etc. In one embodiment, a user interface is created for viewing the results. This user interface can be accessed over a network, via the Internet, etc., using a dedicated application, a browser or other suitable software.

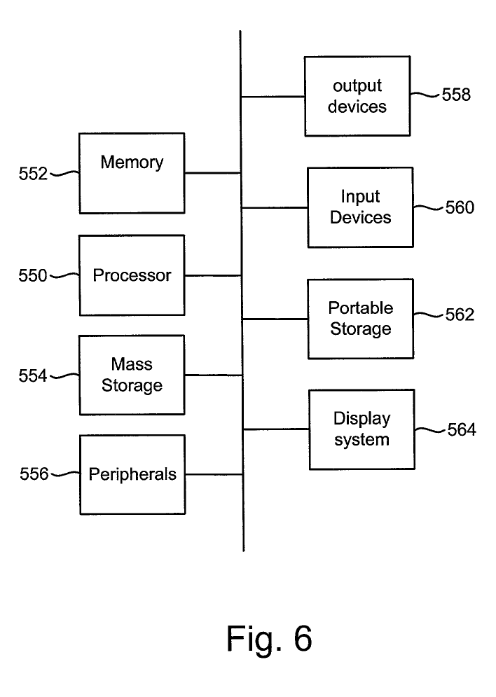

FIG. 6 illustrates a high level block diagram of a computer system which can be used to implement the present invention. The computer system of FIG. 6 includes one or more processors 550 and main memory 552. Main memory 552 stores, in part, instructions and data for execution by processor unit 550. If the system of the present invention is wholly or partially implemented in software, main memory 552 can store the executable code when in operation. The system of FIG. 6 further includes a mass storage device 554, peripheral device(s) 556, input device(s) 560, output devices 558, portable storage medium drive(s) 562, and display system 564. For purposes of simplicity, the components shown in FIG. 6 are depicted as being connected via a single bus; however, the components may be connected through one or more data transport means. Mass storage device 554, which may be implemented with a magnetic disk drive or an optical disk drive, is a non-volatile storage device for storing data and instructions for use by processor unit 550. In one embodiment, mass storage device 554 stores the system software for implementing the present invention. Portable storage medium drive 562 operates in conjunction with a portable non-volatile storage medium, such as a floppy disk, to input and output data and code to and from the computer system of FIG. 6. In one embodiment, the system software for implementing the present invention is stored on such a portable medium, and is input to the computer system via the portable storage medium drive 562. Peripheral device(s) 556 may include any type of computer support device, such as an input/output (I/O) interface, to add additional functionality to the computer system. For example, peripheral device(s) 556 may include a network interface for connecting the computer system to a network, a modem, a router, etc. User input device(s) 560 may include an alpha-numeric keypad for inputting alpha-numeric and other information, or a pointing device, such as a mouse, a trackball, stylus, or cursor direction keys. Examples of suitable output devices 558 include speakers, printers, network interfaces, monitors, etc.

The components contained in the computer system of FIG. 6 are those typically found in computer systems suitable for use with the present invention, and are intended to represent a broad category of such computer components that are well known in the art. Thus, the computing system of FIG. 6 can be a personal computer, mobile computing device, handheld computing device, cellular telephone, workstation, server, minicomputer, mainframe computer, or any other computing device. The computing system can also include different bus configurations, networked platforms, multi-processor platforms, etc. Various operating systems can be used.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A method for determining information from data, comprising the steps of:
accessing a multi-dimensional data set;
converting said multi-dimensional data set to a single dimensional data set, said single dimensional data set includes information from multiple dimensions of said multi-dimensional data set; and
submitting said single dimensional data set to a data mining process, said data mining process provides a result set.

2. A method according to claim 1, wherein:
said data mining process is an association rules process.

3. A method according to claim 1, wherein:
said data mining process identifies sequential patterns.

4. A method according to claim 1, wherein:
said step of converting includes adding conditional items to items in transactions.

5. A method according to claim 4, wherein:
said step of converting includes determining a state of at least a subset of said conditional items.

6. A method according to claim 1, wherein:
said data set includes sets of related data; and
said step of converting includes performing the following steps for said sets of related data:
identifying a first variable as an item and additional one or more variables as conditions for said item,
creating one or more conditional items for said one or more variables identified as conditions, and
appending said conditional items to said item.

7. A method according to claim 6, wherein:
said data mining process is an associations process.

8. A method according to claim 1, further comprising the steps of:
selecting first data from a data warehouse;
storing said selected first data in a data mart, said selected first data stored in said data mart includes said multi-dimensional data set;
storing said result set;
performing queries on said result set; and
reporting results of said queries.

9. A method according to claim 1, wherein:
said step of submitting includes submitting input files and parameters for multiple iterations of an associations mining tool.

10. A method according to claim 1, wherein said step of converting comprises the steps of:
identifying transactions for said multi-dimensional data set;
identifying items for said multi-dimensional data set;
identifying conditions for said multi-dimensional data set;
creating conditional items based on said conditions; and
adding said conditional items to said items.

11. A method according to claim 10, wherein said step of converting further comprises the step of:
determining a state of at least a subset of said conditions, said step of creating is based on said step of determining a state.

12. A method according to claim 10, further comprising the steps of:
creating an integer map for said single dimensional data set; and
creating an input file for said data mining process based on said single dimensional data set and said integer map.

13. A method according to claim 1, further comprising the steps of:
receiving a set of rules as said result set from said data mining tool;
storing said set of rules;
querying current data to determine which rules are active; and
reporting said rules that are active.

14. A method according to claim 1, further comprising the step of:
reporting said result set.

15. A method according to claim 1, wherein:
said result set includes association rules.

16. A method according to claim 1, wherein said step of converting includes the steps of:
associating sets of two or more initial transactions to create overlapping intervals, said initial transactions include items;
modifying said items to identify periods within said intervals; and
grouping said modified items into new transactions based on said overlapping intervals to create input data.

17. A method according to claim 16, wherein:
said result set identifies sequential patterns.

18. A method according to claim 1, wherein:
said data mining process is a sequential patterns data mining tool.

19. A method for transforming a data set for use with a data mining process, said data set includes sets of related data, said method comprising the steps of:
identifying one or more items for each set of related data;
identifying one or more conditions for each item;
creating one or more conditional items for said one or more conditions; and
appending said conditional items to said items.

20. A method according to claim 19, wherein:
each set of related data is a transaction;
each transaction includes a set of variables;
at least one variable per transaction is identified as being an item; and
at least another variable per transaction is identified as being a condition for said item.

21. A method according to claim 19, wherein:
a particular item is represented by first text;
a particular conditional item is represented by second text; and
said step of appending includes appending said second text to said first text.

22. A method according to claim 19, wherein said step of creating includes the step of:
determining a state of at least a subset of said conditional items.

23. A method according to claim 19, wherein:
each item has one conditional item appended.

24. A method according to claim 19, wherein:
multiple conditional items are appended to each item.

25. A method according to claim 19, further comprising the step of:
storing said data set after said step of appending.

26. A method according to claim 19, further comprising the step of:
reporting said data set after said step of appending.

27. A method according to claim 19, further comprising the steps of:
providing said data set to said data mining process after said step of appending;
receiving results from said data mining process; and
reporting based on said results from said data mining process.

28. A method for determining information from data, comprising the steps of:
converting a multi-dimensional data set to a one dimensional data set with sequence; and
submitting said one dimensional data set with sequence to an association rules data mining process, said association rules data mining process provides a result set of rules, said rules identify sequential patterns in said multi-dimensional data set.

29. A method according to claim 28, wherein:
said rules are associations rules.

30. A method according to claim 28, wherein said step of converting comprises the steps of:
accessing a plurality of initial transactions, each initial transaction includes at least one item;
associating sets of two or more initial transactions to create overlapping intervals;
modifying said items to identify periods within said intervals; and
grouping said modified items into new transactions based on said overlapping intervals to create input data.

31. A method according to claim 30, wherein:
said periods correspond to said initial transactions.

32. A method according to claim 30, wherein:
said step of modifying includes adding ordinal items to said items, said ordinal items indicate said periods.

33. A method according to claim 30, wherein said step of converting further comprises performing the following steps for said initial transactions:
identifying a first variable as said item and additional one or more variables as conditions for said item;
creating one or more conditional items for said one or more variables identified as conditions; and
appending said one or more conditional items to said item, said step of appending being performed prior to said step of accessing.

34. A method according to claim 33, wherein:
said step of modifying includes adding ordinal items to said items, said ordinal items indicate said periods.

35. A method according to claim 33, wherein:
said step of creating one or more conditional items includes determining a state of at least a subset of said conditional items.

36. A method according to claim 28, further comprising the steps of:
querying current data to determine which of said rules are active; and
reporting said rules that are active.

37. A method for determining information from a data set, comprising the steps of:
accessing data, said data including a plurality of initial transactions, each initial transaction includes at least one item;
associating sets of two or more initial transactions to create overlapping intervals;
modifying said items to identify periods within said intervals;
grouping said modified items into new transactions based on said overlapping intervals to create input data; and
submitting said grouped modified items to a data mining process, said data mining process provides a result set.

38. A method according to claim 37, wherein:
said periods correspond to said initial transactions.

39. A method according to claim 37, wherein:
said step of modifying includes adding ordinal items to said items, said ordinal items indicate said periods.

40. A method according to claim 37, wherein:
said result set indicates sequential patterns.

41. A method according to claim 37, wherein:
said result set includes association rules.

42. A method according to claim 37, wherein:
said result set includes association rules that indicate sequential patterns.

43. A method according to claim 37, wherein:
said result set includes association rules; and
said result set indicates sequential patterns.

44. A method according to claim 37, wherein:
said data mining process is a one dimensional association rules data mining process.

45. A method according to claim 37, further comprises performing the following steps for said initial transactions:
identifying a first variable as said item and additional one or more variables as conditions for said item;
creating one or more conditional items for said one or more variables identified as conditions; and
appending said one or more conditional items to said item, said step of appending being performed prior to said step of accessing data.

46. A method according to claim 37, wherein:
said step of one or more creating conditional items includes determining a state of at least a subset of said conditional items.

47. One or more processor readable storage devices having processor readable code embodied on said processor readable storage devices, said processor readable code for programming one or more processors to perform a method comprising the steps of:
accessing a multi-dimensional data set;
converting said multi-dimensional data set to a single dimensional data set, said single dimensional data set includes information from multiple dimensions of said multi-dimensional data set; and
submitting said single dimensional data set to a data mining process, said data mining process provides a result set.

48. One or more processor readable storage devices according to claim 47, wherein:
said data mining process is an association rules data mining process.

49. One or more processor readable storage devices according to claim 47, wherein:
said step of converting includes adding conditional items to items in transactions.

50. One or more processor readable storage devices according to claim 49, wherein:
said step of converting includes determining a state of at least a subset of said conditional items.

51. One or more processor readable storage devices according to claim 47, wherein said method further comprises the steps of:
receiving a set of rules as said result set from said data mining tool;
storing said set of rules;
querying current data to determine which rules are active; and
reporting said rules that are active.

52. One or more processor readable storage devices having processor readable code embodied on said processor readable storage devices, said processor readable code for programming one or more processors to perform a method for transforming a data set for use with a data mining process, said data set includes sets of related data, said method comprising the steps of:
identifying one or more items for each set of related data;
identifying one or more conditions for each item;
creating one or more conditional items for said one or more conditions; and
appending said conditional items to said items.

53. One or more processor readable storage devices according to claim 52, wherein:
each set of related data is a transaction;
each transaction includes a set of variables;
at least one variable per transaction is identified as being an item; and
at least another variable per transaction is identified as being a condition for said item.

54. One or more processor readable storage devices according to claim 52, wherein:
a particular item is represented by first text;
a particular conditional item is represented by second text; and
said step of appending includes appending said second text to said first text.

55. One or more processor readable storage devices according to claim 52, wherein said step of creating includes the step of:
determining a state of at least a subset of said conditional items.

56. One or more processor readable storage devices according to claim 52, wherein said method further comprises the steps of:
providing said data set to said data mining process after said step of appending;
receiving results from said data mining process; and
reporting based on said results from said data mining process.

57. One or more processor readable storage devices having processor readable code embodied on said processor readable storage devices, said processor readable code for programming one or more processors to perform a method comprising the steps of:
converting a multi-dimensional data set to a one dimensional data set with sequence; and
submitting said one dimensional data set with sequence to an association rules data mining process, said association rules data mining process provides a result set of rules, said rules identify sequential patterns in said multi-dimensional data set.

58. One or more processor readable storage devices according to claim 57, wherein:
said rules are associations rules.

59. One or more processor readable storage devices according to claim 57, wherein said step of converting comprises the steps of:
accessing a plurality of initial transactions, each initial transaction includes at least one item;
associating sets of two or more initial transactions to create overlapping intervals;
modifying said items to identify periods within said intervals; and
grouping said modified items into new transactions based on said overlapping intervals to create input data.

60. One or more processor readable storage devices according to claim 59, wherein:
said periods correspond to said initial transactions.

61. One or more processor readable storage devices according to claim 59, wherein:
said step of modifying includes adding ordinal items to said items, said ordinal items indicate said periods.

62. One or more processor readable storage devices according to claim 59, wherein said step of converting further comprises performing the following steps for said initial transactions:
identifying a first variable as said item and additional one or more variables as conditions for said item;
creating one or more conditional items for said one or more variables identified as conditions; and
appending said one or more conditional items to said item, said step of appending being performed prior to said step of accessing.

63. One or more processor readable storage devices according to claim 57, wherein said method further comprises the steps of:
querying current data to determine which of said rules are active; and
reporting said rules that are active.

64. One or more processor readable storage devices having processor readable code embodied on said processor readable storage devices, said processor readable code for programming one or more processors to perform a method comprising the steps of:
accessing data, said data including a plurality of initial transactions, each initial transaction includes at least one item;
associating sets of two or more initial transactions to create overlapping intervals;
modifying said items to identify periods within said intervals;
grouping said modified items into new transactions based on said overlapping intervals to create input data; and
submitting said grouped modified items to a data mining process, said data mining process provides a result set.

65. One or more processor readable storage devices according to claim 64, wherein:
said periods correspond to said initial transactions.

66. One or more processor readable storage devices according to claim 64, wherein:
said step of modifying includes adding ordinal items to said items, said ordinal items indicate said periods.

67. One or more processor readable storage devices according to claim 64, wherein:
said result set indicates sequential patterns.

68. One or more processor readable storage devices according to claim 64, wherein:
said result set includes association rules; and
said result set indicates sequential patterns.

69. One or more processor readable storage devices according to claim 64, wherein:
said data mining process is a one dimensional association rules data mining process.

70. An apparatus, comprising:
one or more storage devices; and
one or more processors in communication with said one or more storage devices, said one or more processors perform a method comprising the steps of:
accessing a multi-dimensional data set,
converting said multi-dimensional data set to a single dimensional data set, said single dimensional data set includes information from multiple dimensions of said multi-dimensional data set, and
submitting said single dimensional data set to a data mining process, said data mining process provides a result set.

71. An apparatus according to claim 70, wherein:
said data mining process is an association rules data mining process.

72. An apparatus according to claim 71, wherein:
said step of converting includes adding conditional items to items in transactions.

73. An apparatus according to claim 72, wherein:
said step of converting includes determining a state of at least a subset of said conditional items.

74. An apparatus according to claim 73, wherein said method further comprises the steps of:
receiving a set of rules as said result set from said data mining tool;
storing said set of rules;
querying current data to determine which rules are active; and
reporting said rules that are active.

75. An apparatus, comprising:
one or more storage devices; and
one or more processors in communication with said one or more storage devices, said one or more processors perform a method for transforming a data set for use with a data mining process, said data set includes sets of related data, said method comprising the steps of:
identifying one or more items for each set of related data,
identifying one or more conditions for each item,
creating one or more conditional items for said one or more conditions, and
appending said conditional items to said items.

76. An apparatus according to claim 75, wherein:
each set of related data is a transaction;
each transaction includes a set of variables;
at least one variable per transaction is identified as being an item; and
at least another variable per transaction is identified as being a condition for said item.

77. An apparatus according to claim 76, wherein:
a particular item is represented by first text;
a particular conditional item is represented by second text; and
said step of appending includes appending said second text to said first text.

78. An apparatus according to claim 77, wherein said step of creating includes the step of:
determining a state of at least a subset of said conditional items.

79. An apparatus, comprising:
one or more storage devices; and
one or more processors in communication with said one or more storage devices, said one or more processors perform a method comprising the steps of:
converting a multi-dimensional data set to a one dimensional data set with sequence, and
submitting said one dimensional data set with sequence to an association rules data mining process, said association rules data mining process provides a result set of associations rules, said rules identify sequential patterns in said multi-dimensional data set.

80. An apparatus according to claim 79, wherein said step of converting comprises the steps of:
accessing a plurality of initial transactions, each initial transaction includes at least one item;
associating sets of two or more initial transactions to create overlapping intervals;
modifying said items to identify periods within said intervals; and
grouping said modified items into new transactions based on said overlapping intervals to create input data.

81. An apparatus according to claim 80, wherein:
said step of modifying includes adding ordinal items to said items, said ordinal items indicate said periods.

82. An apparatus according to claim 81, wherein said step of converting further comprises performing the following steps for said initial transactions:
identifying a first variable as said item and additional one or more variables as conditions for said item;
creating one or more conditional items for said one or more variables identified as conditions; and
appending said one or more conditional items to said item, said step of appending being performed prior to said step of accessing.

83. An apparatus according to claim 82, wherein said method further comprises the steps of:
querying current data to determine which of said rules are active; and
reporting said rules that are active.

84. An apparatus, comprising:
one or more storage devices; and
one or more processors in communication with said one or more storage devices, said one or more processors perform a method comprising the steps of:
accessing data, said data including a plurality of initial transactions, each initial transaction includes at least one item,
associating sets of two or more initial transactions to create overlapping intervals,
modifying said items to identify periods within said intervals,
grouping said modified items into new transactions based on said overlapping intervals to create input data, and
submitting said grouped modified items to a data mining process, said data mining process provides a result set.

85. An apparatus according to claim 84, wherein:
said periods correspond to said initial transactions.

86. An apparatus according to claim 84, wherein:
said step of modifying includes adding ordinal items to said items, said ordinal items indicate said periods; and
said result set indicates sequential patterns.

87. An apparatus according to claim 86, wherein:
said result set includes association rules that indicate sequential patterns; and
said data mining process is a one dimensional association rules data mining process.
